(19) United States
(12) Patent Application Publication
(10) Pub. No.: US 2026/0025874 A1
(43) Pub. Date: Jan. 22, 2026

(54) INTELLIGENT BANDWIDTH PARTS ALLOCATION

(71) Applicant: T-Mobile Innovations LLC, Overland Park, KS (US)

(72) Inventor: John Carlo VENTURA, Sammamish, WA (US)

(21) Appl. No.: 18/779,619

(22) Filed: Jul. 22, 2024

(51) Int. Cl. H04W 76/18; H04W 24/04; H04W 72/231

(52) U.S. Cl. CPC H04W 76/18; H04W 24/04; H04W 72/231

(57) ABSTRACT

Methods and systems provided herein include intelligent bandwidth parts allocation to improve overall network performance. A method includes determining that the number of connectivity failures of a wireless device configured in accordance with its advertised bandwidth meets a predetermined threshold and reconfiguring the wireless device to utilize a new assigned bandwidth that differs from the advertised supported bandwidth received from the wireless device.

### TECHNICAL BACKGROUND

As wireless networks evolve and grow, ongoing challenges arise in communicating data across different types of networks. For example, a wireless network may include one or more access nodes, such as base stations including evolved NodeBs (eNBs) or next generation NodeBs (gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, as well as 6G or 4G long-term evolution (LTE) access nodes.

In Release 15, the 3GPP specified some new features for 5G, including Bandwidth Parts (BWP), which includes a set of contiguous physical resource blocks (PRBs). Before BWP, a wireless device using a carrier, would use the full bandwidth of the carrier whenever it was transmitting via that carrier. Use of the full carrier is not necessarily bandwidth efficient and since it takes more power to transmit the full bandwidth, it is wasteful of power as well.

With BWP, the full bandwidth carrier can be broken into as many as four separate BWPs. Each BWP can have its own configuration, which can be increased or decreased as necessary, and allows for a much more efficient use of bandwidth and power. This can help preserve the battery life of wireless devices. Additionally, BWP can help support legacy devices that might not support the new bandwidths introduced with 5G. For example, a BWP may be setup that is configured to support legacy 4G devices. The 4G devices can be serviced and the remainder of the carrier is available to service other wireless devices. Part of the efficiency improvement of BWP is that a wireless device may be configured to use only as much bandwidth as necessary instead of using the whole bandwidth of the carrier. The use of bandwidth parts enables the wireless devices to operate in a narrow bandwidth and when the user demands more data, it can inform the access node to enable a wider bandwidth. Currently, a maximum of four BWP can be specified in both downlink (DL) and uplink (UL). Utilizing bandwidth parts provides an energy efficient solution when the use of wide bandwidth is not required.

In operation, access nodes broadcast their available bandwidth to wireless devices within a coverage area. In response, in networks that support bandwidth parts (BWP), the wireless devices will advertise their supported bandwidth combination and NR carrier aggregation (CA) combination. However, situations occur in which wireless devices falsely or incorrectly advertise their supported bandwidth or BWP settings. For example, the wireless device may advertise that it supports the full available bandwidth broadcast by the access node, but in reality may only support less than the full available bandwidth, e.g., one, two, or three bandwidth parts, but not the full bandwidth. Alternatively, the wireless device may advertise that it supports only one, two, or three bandwidth parts, when in reality, the wireless device supports only the full available bandwidth and does not support BWP.

As a result of the wireless devices falsely advertising supported bandwidth, access failure will happen, and the wireless device will not be able to connect to the network. This process can result in loops of failures. Similarly, in some cases, the wireless device will initially connect to the advertised bandwidth, but later drops. This process can also result into loops of drops. Network key performance indicators (KPIs) such as access failure rate and drop call rate surge as a result of incorrect BWP configurations for accessing the network with both primary cell (Pcell) or with NR Carrier Aggregation (CA) combinations.

Accordingly, a solution is needed for intelligently handling false advertisements from the wireless devices in order to make the network robust and agile and reduce the above-mentioned connectivity failures.

### Overview

Exemplary embodiments provided herein include a method for intelligent allocation of bandwidth parts. The method includes receiving, in response to a broadcasted available bandwidth, capability information from a wireless device including an advertised supported bandwidth. The method includes performing radio resource control (RRC) setup or configuration based on the received capability information to assign the advertised supported bandwidth to the wireless device. The method further includes monitoring connectivity failures of the wireless device and comparing the monitored connectivity failures to a predetermined threshold number of connectivity failures. Upon determining that the number of connectivity failures meets the predetermined threshold, the method includes reconfiguring the wireless device to utilize a new assigned bandwidth that differs from the advertised supported bandwidth received from the wireless device.

In a further aspect, a system is provided for intelligently allocating bandwidth parts. The system includes data and instructions and a processor executing the stored instructions to perform multiple operations. The operations include including triggering radio resource control (RRC) configuration based on advertised supported bandwidth capability information from a wireless device to assign the advertised supported bandwidth to the wireless device. The operations further include monitoring connectivity failures of the wireless device and comparing the monitored connectivity failures to a predetermined threshold number of connectivity failures. Upon determining that the number of connectivity failures meets the predetermined threshold, the operations include reconfiguring the wireless device to utilize a new assigned bandwidth that differs from the advertised supported bandwidth received from the wireless device.

In an additional aspect, a method is provided including triggering radio resource control (RRC) setup or configuration based on advertised supported bandwidth capability information from a wireless device to assign the advertised supported bandwidth to the wireless device. The method additionally includes determining that a number of connectivity failures of the wireless device having the assigned supported bandwidth meets or exceeds a predetermined threshold and reconfiguring the wireless device to utilize a new assigned bandwidth that differs from the advertised supported bandwidth received from the wireless device. The method additionally includes triggering a correction to the advertised supported bandwidth transmitted by the wireless device.

In yet additional embodiments, a non-transitory computer-readable mediums may store instructions executed by a processor to perform the operations described above. Further, a processing node performing the operations described herein may be utilized.

### BRIEF DESCRIPTION OF THE DRAWINGS

FIG. 1 depicts an exemplary environment for intelligently allocating bandwidth parts in accordance with an embodiment.

FIG. 2 depicts an exemplary bandwidth parts allocation system in accordance with an embodiment.

FIG. 3 depicts an exemplary access node in accordance with an embodiment.

FIG. 4A depicts an exemplary method for bandwidth parts allocation in accordance with an embodiment.

FIG. 4B depicts a further exemplary for improving network performance following the method of FIG. 4A.

FIG. 5 depicts a further exemplary method for bandwidth parts allocation in accordance with an embodiment.

FIG. 6 depicts a scenario for bandwidth parts allocation in accordance with an embodiment.

FIGS. 7A and 7B illustrate further exemplary scenarios for bandwidth parts allocation in accordance with embodiments disclosed herein.

### DETAILED DESCRIPTION

Embodiments provided herein include a method for intelligently allocating bandwidth parts (BWP) by a network component despite false advertising of bandwidth parts supported by wireless devices. Embodiments provided herein operate within the access node or base station or within a processing node connected to the base station. The system for intelligently allocating bandwidth parts as described herein is fault aware and self-healing based on recognized failures of wireless device connections.

Failures include, for example, access failures, which occur when a wireless device is attempting to connect to the network and dropped calls, which occur after the wireless device has initially connected to the network. Thus, when such failures occur during bandwidth part operations for a predetermined threshold number of times, the intelligence described herein concludes that the wireless device does not support the allotted bandwidth parts. The predetermined threshold may be network-operator configurable and may be specific to the characteristics of the network. For example, the threshold may be ten failed connections or fifteen failed connections or any other operator configurable number. Furthermore, the threshold may apply to access failure rate (AFR) combined with dropped call rate (DCR) or may be applied to each of AFR and DCR individually. Once the threshold is reached, the bandwidth parts allocation system disclosed herein determines that the wireless device does not support the configured bandwidth that was advertised in the wireless device capability report.

Accordingly, in embodiments disclosed herein, the BWP allocation system causes the gNB or processing node in the RAN to reconfigure and allot a different bandwidth part or set of bandwidth parts to the wireless device than the capability advertised by the wireless device. Accordingly, when the wireless device advertised the full available bandwidth in its capability report, the BWP allocation system allots less than the full bandwidth to the wireless device. Conversely, then the wireless device advertised one or more bandwidth parts equaling less than the full available bandwidth, the bandwidth allocation system causes the gNB or Radio Access Network (RAN) to reconfigure it the wireless device back to a partial bandwidth.

Additionally, when any particular wireless device type habitually advertises an incorrect bandwidth, connectivity failures will be routine for that type of device and the BWP allocation system will repeatedly trigger alterations to allotted bandwidth for the device type. The repeated failures negatively impact the network as a whole. Accordingly, in embodiments described herein, the bandwidth allocation system incorporates a counter to determine how many times the bandwidth allocation adjustment loop occurs for a particular device. Another operator configured threshold may be implemented to trigger a notification to a device or software manufacturer that an upgrade or correction is needed for the device type in order to prevent the wireless device type from falsely advertising its bandwidth. The correction can include, for example, a software upgrade.

Accordingly, embodiments disclosed herein provide intelligent methods for handling false advertisements of bandwidth capabilities from wireless devices. These methods make the network more robust and agile. An exemplary system described herein includes at least an access node (or base station), such as a next generation NodeB (gNodeB), and a plurality of end-user wireless devices. For illustrative purposes and simplicity, the disclosed technology will be illustrated and discussed as being implemented in the communications between an access node (e.g., a base station) and a wireless device (e.g., an end-user wireless device).

In addition to the systems and methods described herein, the operations for bandwidth allocation may be implemented as computer-readable instructions or methods and processing nodes on the network for executing the instructions or methods. The processing node may include a processor included in the access node or a processor included in any controller node in the wireless network that is coupled to the access node.

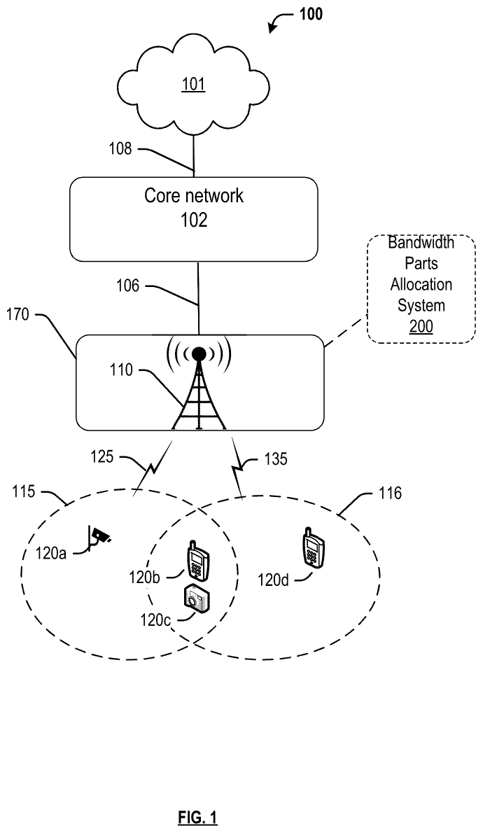

FIG. 1 depicts an exemplary environment 100 for intelligently allocating bandwidth parts in a wireless network. In the displayed environment 100, a bandwidth parts allocation system 200 operates to assign bandwidth for wireless devices 120a, 120b, 120c, and 120d. The wireless devices 120a, 120b, 120c, and 120d may include, for example, enhanced mobile broadband (eMBB) devices or internet of things (IoT) devices.

Environment 100 comprises a communication network 101, core network 102, and a radio access network (RAN) 170 including at least an access node 110. Wireless devices 120a-d communicate with the access node 110. Further, a bandwidth parts allocation system 200 operates to intelligently allocate bandwidth parts to the wireless devices 120a . . . 120d. Additionally, components not shown may include, for example, gateway node(s) controller nodes, and additional access nodes.

Access node 110 can be any network node configured to provide communication between end-user wireless devices 120a-d and communication network 101, including standard access nodes and/or short range, low power, small access nodes. For instance, access node 110 may include any standard access node, such as a macrocell access node, base transceiver station, a radio base station, an eNodeB device, an enhanced eNodeB device, a next generation NodeB device (gNBs) in 5G networks, or the like.

Further the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless devices 120a-d are illustrated in FIG. 1, any number of access nodes and wireless devices can be implemented within environment 100.

As further described herein, by utilizing antennas, access node 110 can deploy a wireless air interface using one or more frequency bands over one or more coverage areas 115, 116. Higher frequency bands may result in smaller coverage areas and lower frequency bands may result in larger coverage areas. Various portions of the electromagnetic spectrum may be utilized. For example, 5G NR communication utilizes frequencies below 6 GHz (Frequency Range 1) and above 24 GHz (Frequency Range 2), which are further divided into a plurality of bands which themselves may be further divided into component carriers (CCs) and further into BWPs.

Further, the different sets of antennas can be used to implement various transmission modes or operating modes in each sector, including but not limited to multiple in multiple out (MIMO) (including single user-MIMO, multi-user-MIMO, massive MIMO, beamforming, etc.), carrier aggregation (including inter-band and intra-band carrier aggregation), and different duplexing modes including frequency division duplexing (FDD) and time division duplexing (TDD).

For example, as illustrated herein, some of the antennas of access node 110 can be allocated towards deploying a first carrier using wireless connection 125. Other antennas having a first frequency and other antennas of access node 110 can be allocated towards deploying a second carrier using a second frequency, to which wireless devices attach using wireless connection 135. Additionally, multiple access nodes may be provided, each deploying multiple antennas. Further, different carriers may utilize different modes or the same modes of operation include FDD or TDD modes of operation.

The exemplary operating environment 100 may further include bandwidth parts allocation system 200, which is illustrated as operating as a processing node communicated with the RAN 170. However, it should be noted that the bandwidth parts allocation system 200 may operate in the RAN 170 and may be incorporated in one or more nodes of the RAN 170, for example an access node 110 or a controller node. Alternatively, the bandwidth parts allocation system 200 may be an entirely discrete system operating in conjunction with the RAN 170.

The bandwidth parts allocation system 200 receives information pertaining to bandwidth parts supported by the wireless devices 120a-120d from the wireless devices 120a-120d. While some wireless devices may support a full bandwidth spectrum available from the access node 110, others may support various combinations of bandwidth parts. In response to a broadcast of available bandwidth from the access node 110, the wireless devices 120a-120d respond by advertising a corresponding supported bandwidth. In embodiments set forth herein, the wireless devices 120a-120d may send these parameters to the access nodes 110, which convey the relevant parameters to the bandwidth parts allocation system 200.

While the bandwidth parts allocation system 200 and/or the access node 110 may respond to the wireless devices 120a-120d by allocating the advertised bandwidth parts to the corresponding wireless devices 120a-120d, the bandwidth parts allocation system 200 analyzes connectivity failures after the allocation of the advertised bandwidth parts to the corresponding wireless devices 120a-120d. For example, the bandwidth parts allocation system 200 may monitor connectivity failures of the corresponding wireless device by implementing a configurable predetermined threshold and a counter. When the number of connectivity failures tabulated by the counter meets the configurable predetermined threshold, the bandwidth parts allocation system 200 may determine that a corresponding wireless device has falsely advertised its supported bandwidth. Accordingly, the bandwidth parts allocation system 200 may trigger reallocation of bandwidth parts to the corresponding wireless device. For example, if the corresponding wireless device 120a-120d advertises support for the full available bandwidth spectrum, the bandwidth parts allocation system 200 may trigger reallocation of less than full bandwidth parts to the wireless device. Alternatively, if the corresponding wireless device advertises support for half of the available spectrum, the bandwidth parts allocation system 200 may trigger allocation of the full bandwidth spectrum to the corresponding wireless device. The reallocation may be performed, for example, using a radio resource connection (RRC) reconfiguration message from the access node 110.

Further, in embodiments disclosed herein, the bandwidth parts allocation system 200 identifies a device type for each device experiencing the threshold number of connectivity failures. The bandwidth parts allocation system 200 then tracks a quantity of each device type in conjunction with the connectivity failures based on a second threshold. For example, the bandwidth parts allocation system 200 may determine that if a threshold number of devices of certain device type, e.g., one hundred devices of a particular type experience the threshold number of connectivity failures, then the device type routinely falsely advertises its bandwidth capabilities. Accordingly, the bandwidth parts allocation system 200 triggers an upgrade for the device type. The upgrade could be triggered by notifying the device manufacturer or software vendor that correction is required. Further, until the correction is actually achieved, the bandwidth parts allocation system 200 may record the device type and trigger a reallocation of bandwidth prior to reaching the threshold number of connectivity failures for that particular device type.

Access node 110 can comprise a processor and associated circuitry to execute or direct the execution of computer-readable instructions to perform operations such as those further described herein. Briefly, access node 110 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access node 110 can receive instructions and other input at a user interface. Access node 110 is capable of communicating with the core network 102 as well as various additional nodes including gateway nodes, controller nodes, and other access nodes.

Further, the access node 110 may communicate with the bandwidth parts allocation system 200 or alternatively may wholly or partially incorporate the bandwidth parts allocation system 200. Thus, the bandwidth parts allocation system 200 may collect data from the access node 110 and/or the wireless devices 120a-120d. The bandwidth parts allocation system 200 may perform processing in order to trigger scheduling at the access node 110.

Wireless devices 120a-120d may be any device, system, combination of devices, or other such communication platform capable of communicating wirelessly with access node 110 using one or more frequency bands deployed therefrom. Wireless devices 120a-120d may be or include RedCap devices, which include IoT devices forming a network of physical objects or things that are embedded with sensors, software, and other technologies for the purpose of connecting and exchanging data with other devices and systems over the Internet. Wireless devices may alternatively be eMBB devices and may include, for example, a mobile phone, a wireless phone, a wireless modem, a personal digital assistant (PDA), a voice over internet protocol (VOIP) phone, a voice over packet (VOP) phone, a soft phone, a home internet (HINT) device, a fixed wireless access (FWA) device as well as other types of devices or systems that can exchange audio or data via access node 110. The mobile devices 120a-120d may be capable of interacting with multiple carriers using CA, which allows the wireless devices 120a-120d to utilize multiple carriers at the same time, thus increasing the amount of data that can be transmitted at the same time.

Subsequent to sending capabilities to the access node 110, for example, through a user equipment (UE) capability information message, and receiving initial bandwidth spectrum allocation, the wireless devices 120a-120d may be tracked or monitored by the bandwidth parts allocation system 200. Further bandwidth allocation may result from the monitoring as described above.

The core network 102 includes core network functions and elements. The core network may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120a-120d and is responsible for handling connection and mobility management tasks. The SMF is primarily responsible for creating, updating, and removing sessions and managing session context. The UDM function provides services to other core functions, such as the AMF, SMF, and NEF. The UDM function may function as a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 120a-d. Wireless network protocols can comprise multimedia broadcast multicast service (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Communications links 106 may include S1 communications links. Other wireless protocols can also be used. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

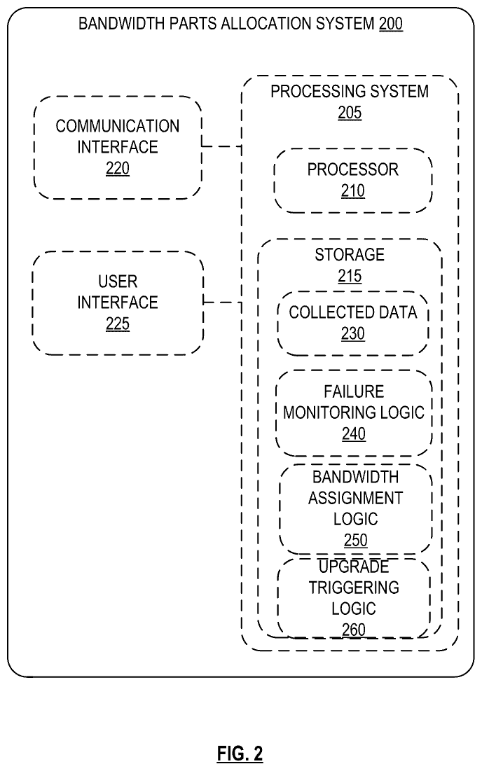

FIG. 2 illustrates a bandwidth parts allocation system 200 in accordance with embodiments described herein. The components described herein are merely exemplary as many different configurations for the bandwidth parts allocation system 200 may be implemented. The bandwidth parts allocation system 200 may be configured to perform the methods and operations disclosed herein to intelligently allocate bandwidth in order to improve overall network performance. In the disclosed embodiments, the bandwidth parts allocation system 200 may be integrated with each access node 110 or may be an entirely separate component capable of communicating with the access node(s) 110. Further, the components of the bandwidth parts allocation system 200 may be distributed so that one or more components are located at an access node 110 and one or more other components are located within a separate processing node.

The bandwidth parts allocation system 200 may be configured for collecting data transmitted by the wireless devices 120a-120d to the access nodes 110. To perform processes for bandwidth parts allocation, the bandwidth parts allocation system 200 may utilize a processing system 205. Processing system 205 may include a processor 210 and a storage device 215. Storage device 215 may include a RAM, ROM, disk drive, a flash drive, a memory, or other storage device configured to store data and/or computer readable instructions or codes (e.g., software). The computer executable instructions or codes may be accessed and executed by processor 210 to perform various methods disclosed herein.

Software stored in storage device 215 may include computer programs, firmware, or other forms of machine-readable instructions, including an operating system, utilities, drivers, network interfaces, applications, or other type of software. For example, software stored in storage device 215 may include one or more modules for performing various operations described herein. For example, failure monitoring logic 240 may store instructions for monitoring connectivity failures of wireless devices 120a-120d based on collected data 230. For example, the failure monitoring logic 240 may identify connectivity failures, count connectivity failures, and compare the number of connectivity failures to a configurable predetermined threshold. Further, for a specific wireless device 120a-120d, the failure monitoring logic 240 may monitor the number of times that a wireless device meets the configurable predetermined threshold for connectivity failures. Bandwidth parts assignment logic 250 is triggered upon detection of the threshold number of failures by the failure monitoring logic. The bandwidth parts assignment logic 250 reassigns bandwidth parts in a manner different from the advertised supported bandwidth parts as further described herein. The upgrade triggering logic 260 may also be triggered by the failure monitoring logic 240. The upgrade triggering logic 260 may be capable of identifying a specific type of wireless device after the wireless device has met the threshold number of connectivity failures. Further, the upgrade triggering logic 260 may count a number of wireless devices of the specific device type meeting the threshold number of connectivity failures. Additionally, the upgrade triggering logic 260 may operate based on a looping threshold. For example, if a specific wireless device, e.g., 120a is repeatedly reconfigured for a number of times meeting the looping threshold, an upgrade may be triggered for the wireless device 120a. Further, the storage device 215 may store the collected data at 230, which may be or include data collected from the wireless devices 120a-120d as well as data collected by the failure monitoring logic 240 and upgrade triggering logic 260.

Processor 210 may be a microprocessor and may include hardware circuitry and/or embedded codes configured to retrieve and execute software stored in storage device 215. The bandwidth parts allocation system 200 further includes a communication interface 220 and a user interface 225. Communication interface 220 may be configured to enable the processing system 205 to communicate with other components, nodes, or devices in the wireless network. For example, the bandwidth parts allocation system 200 receives relevant parameters from an access node 110 or from the wireless devices 120a-d. Communication interface 220 may include hardware components, such as network communication ports, devices, routers, wires, antenna, transceivers, etc. The communication interface 220 may receive data or information from access nodes 110 or the wireless devices 120a-d. User interface 225 may be configured to allow a user to provide input to the bandwidth parts allocation system 200. For example, the user interface 225 may allow input of configurable thresholds. User interface 225 may include hardware components, such as touch screens, buttons, displays, speakers, etc. The bandwidth parts allocation system 200 may further include other components such as a power management unit, a control interface unit, etc.

The location of the bandwidth parts allocation system 200 may depend upon the network architecture. As set forth above, the bandwidth parts allocation system 200 may be located in an access node 110, in a separate processing node, in the RAN 170, in multiple locations, or maybe an entirely discrete component. Further, although shown as a single integrated system, the functions of data collection, failure monitoring, bandwidth parts assignment, and upgrade triggering may be separated and disposed in separate locations.

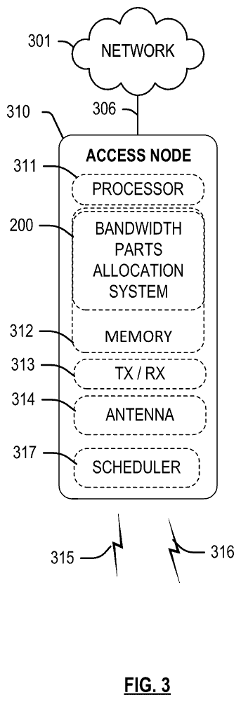

FIG. 3 depicts an exemplary access node 310. Access node 310 is configured as an access point for providing network services from network 301 to end-user wireless devices such as wireless devices 120a-120d in FIG. 1. Access node 310 is illustrated as comprising a memory 312 for storing logical modules that perform operations described herein, a processor 311 for executing the logical modules, and a transceiver 313 for transmitting and receiving signals via antennas 314. Combinations of antennas 314 and transceivers 313 are configured to deploy wireless air interfaces. Further, the different sets of antennas can be used to implement various transmission modes or operating modes in each sector, including but not limited to MIMO (including SU-MIMO, MU-MIMO, mMIMO, beamforming, etc.), CA, and different duplexing modes including FDD and TDD. Further, access node 310 is communicatively coupled to network 301 via communication interface 306, which may be any wired or wireless link as described above. Scheduler 317 may be provided for scheduling resources for the wireless devices 120a-120d. Wireless communication links 315 and 316 may facilitate communication with the wireless devices 120a-120d in both uplink and downlink directions.

In an exemplary embodiment, memory 312 includes a bandwidth parts allocation system 200 performing the functions described above with respect to FIG. 2. In other embodiments, the access node 310 may include only a portion of the bandwidth parts allocation system 200, for example, the bandwidth assignment logic 250, whereas the failure monitoring logic 240, and the upgrade triggering logic 260 may be disposed in a separate processing node.

Further, as the access node 310 is described as performing the methods described herein, processing nodes, gateway nodes, or other nodes in the RAN 170 may employ methods disclosed to perform intelligent bandwidth parts allocation. In some embodiments, the bandwidth parts allocation system 200 may be wholly incorporated in the access node 310. However, in other embodiments, the bandwidth parts allocation system 200 may be a separate processing node providing instructions to the access node 310.

Generally, the allocation of bandwidth parts to wireless devices 120a-120d in response to a request including a UE capability report can be accomplished at the access node 310. The access node 310 may dynamically assign the bandwidth parts to wireless devices 120a-120d based on the UE capability report sent by the wireless devices 120a-120d to the access node 310. The access node 310 may allocate and schedule bandwidth parts within a frequency spectrum for both downlink (DL) and uplink (UL) transmissions. In embodiments set forth herein, the processor 311 and the scheduler 317 may operate to intelligently assign and schedule bandwidth parts for the wireless devices 120a-120d.

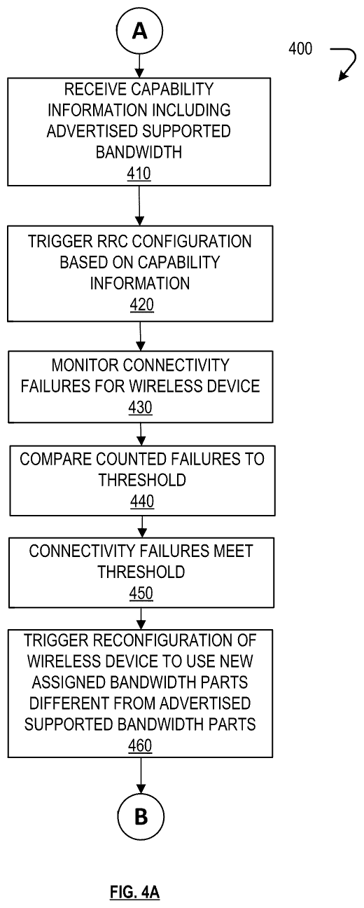

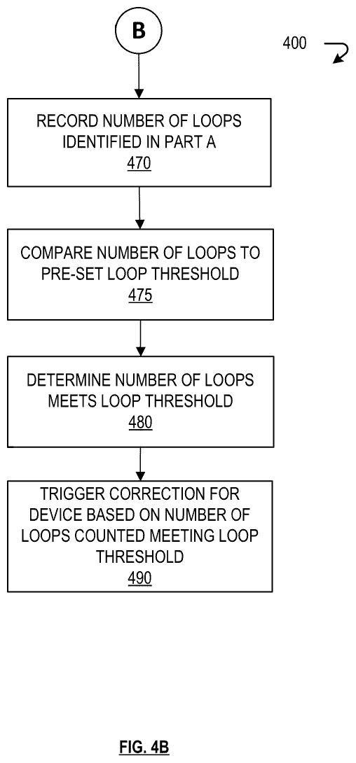

FIG. 4A illustrates part A of an exemplary method 400 for intelligent bandwidth parts allocation in order to improve overall network performance. Method 400 may be performed by any suitable processor discussed herein, for example, a processor included in access node 110 or 310, or the processor 210 included in the bandwidth parts allocation system 200. Alternatively, the method 400 may be performed by a combination of processors. For discussion purposes, as an example, method 400 is described as being performed by the processor 210 included in the bandwidth parts allocation system 200.

Method 400 starts in step 410, in which the processor 210 may receive capability information include advertised supported bandwidth from a wireless device, such as one of the wireless devices 120a-120d. For example, the processor 210 may receive the capability information in the UE capability report. The UE capability report may advertise a supported bandwidth combination and NRCA combination. In step 420, the processor 210 may trigger RRC setup or configuration based on the advertised supported bandwidth contained in the capability information. That is, the wireless device may be allotted bandwidth parts in accordance with the supported bandwidth parts advertised by the wireless device. In embodiments set forth herein, steps 410 and 420 may be performed at or by the access node 110, 310.

The method continues in step 430, in which the processor 210 may monitor connectivity failures for the wireless devices 120a-120d that have been allotted bandwidth parts. The connectivity failures may be or include, for example, access failures and dropped calls. Thus, the wireless devices 120a-120d may fail to connect or may connect and subsequently drop the connection. Accordingly, the processor 210 monitors the access failure rate (AFR) and the dropped call rate (DCR). The monitoring may include implementing a counter for counting the number of connectivity failures for a corresponding wireless device.

In step 440, the processor 210 compares the counted number of connectivity failures to a predetermined configurable threshold. For example, the predetermined threshold may be ten, fifteen, or twenty connectivity failures during a communication session. The predetermined threshold may be configured based on network parameters, for example by a network engineer. In some instances, the processor 210 will determine that the counted connectivity failures meet the predetermined threshold in step 450.

Thus, in step 460, upon determining that the number of connectivity failures meets the predetermined threshold in step 450, the processor 210 triggers reconfiguration of the wireless device to utilize newly assigned bandwidth parts different from the advertised supported bandwidth parts. For example, when a wireless device advertises that it supports the full available bandwidth from the access node 110, 310, then the processor 210 may trigger a reconfiguration to allow the wireless device to utilize one or more bandwidth parts totaling less than the full available bandwidth. Conversely, when the wireless device advertises that it supports one or more bandwidth parts amounting to less than the full available bandwidth, the processor 210 may trigger reconfiguration of the wireless device to utilize the full available bandwidth from the access node 110, 310. Thus the processor 210 may trigger a notification to the access node 110, 310 and reconfiguration may be accomplished by the access node 110, 310 through an RRC reconfiguration message. Upon triggering reconfiguration, the method proceeds to part B, shown in FIG. 4B.

In some embodiments, allocation and scheduling may be performed by the bandwidth parts allocation system 200. However, the bandwidth parts allocation system 200 may operate to determine allocation and spectrum assignment, but provide instructions to the scheduler of the access node 310 in order to trigger scheduling. As set forth herein, the scheduling occurs in a manner calculated to improve overall network performance.

FIG. 4B illustrates part B of the exemplary method 400 for intelligent bandwidth parts allocation in order to improve overall network performance. Part B of method 400 may be performed by any suitable processor discussed herein, for example, a processor included in access node 110 or 310, or the processor 210 included in the bandwidth parts allocation system 200. Alternatively, the method 400 may be performed by a combination of processors. For discussion purposes, as an example, method 400 is described as being performed by the processor 210 included in the bandwidth parts allocation system 200.

Part B of method 400 starts in step 470, in which the processor 210 implements a counter to count each loop referenced in FIG. 4A. For example, once any one of the wireless devices 120a-120d reach the threshold number of failures and are reconfigured with bandwidth parts different from the bandwidth parts advertised by the wireless devices 120a-120d, one loop has been completed as set forth relation to step 450.

In step 475, a loop threshold may be compared to the counted number of loops. The loop threshold may be set, for example to ten, fifteen, or twenty loops. The number of loops may be compared to the counted or recorded loops by the processor 210. In step 480, the processor 210 determines that the number of loops counted meets the loop threshold. Based on this determination, in step 490, the processor 210 may trigger a correction for the device. The correction may be or include a permanent change to device settings or a permanent change to the bandwidth parts allocated to a corresponding wireless device. The triggering of the correction by the processor 210 may trigger a correction that can be stored at the access node 110, 310 or a correction that can be implemented by a device manufacturer or software vendor. Triggering of a correction in step 490 may further include triggering a correction to the capability information transmitted by the wireless device to alter the advertised supported bandwidth. Triggering a correction may further include triggering a software upgrade for the device.

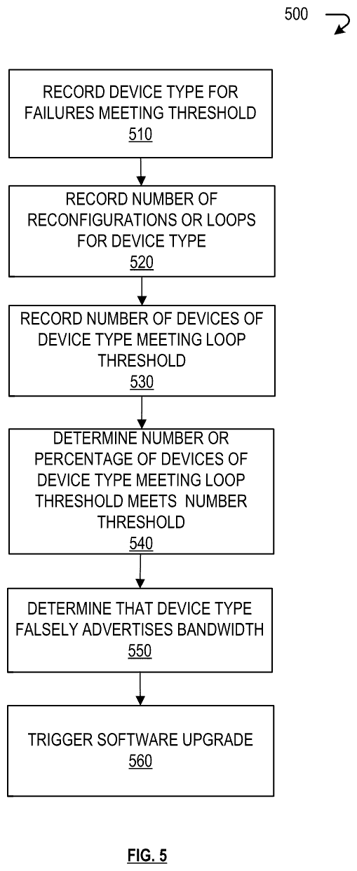

FIG. 5 depicts an exemplary method 500 for triggering corrections for allocation of bandwidth parts to wireless devices 120a-120d. Method 500 may be performed by any suitable processor discussed herein, for example, a processor included in access node 110 or 310, or the processor 210 in the bandwidth parts allocation system 200. For discussion purposes, as an example, method 500 is described as being performed by a processor 210.

In step 510, the processor 210 records a device type for failures meeting the threshold described with reference to FIG. 4A. Thus, the processor 210 identifies a device type for each wireless device meeting or exceeding the threshold. The device type may be, for example, Apple iPhone® 13 or Samsung Galaxy® 12.

In step 520, the processor records the number of loops or reconfigurations for each device. Subsequently in step 530, the processor 210 compares the number of loops to the loop threshold and further counts the number of devices of the device type meeting the loop threshold. For example, the processor 210 may determine that one hundred iPhone® 13s meet a loop threshold of ten loops.

In step 540, the processor 210 compares the number of devices of the device type in a coverage area meeting the loop threshold to a preset threshold number of devices. For example, the preset threshold may be one hundred devices of the device type. The preset threshold may alternatively be a threshold percentage. When the processor 210 determines that the number of devices of the device type meeting the loop threshold also meets the threshold number of devices, the processor concludes in step 550 that the device type falsely advertises its bandwidth capabilities. Based on this determination, in step 560, the processor 210 triggers a correction to the bandwidth capability advertising for the device type. The correction may be made, for example, by may triggering a notification to a device manufacturer or software vendor that an update to the bandwidth capability for the device type is required.

In some embodiments, methods 400 and 500 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400 and 500 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

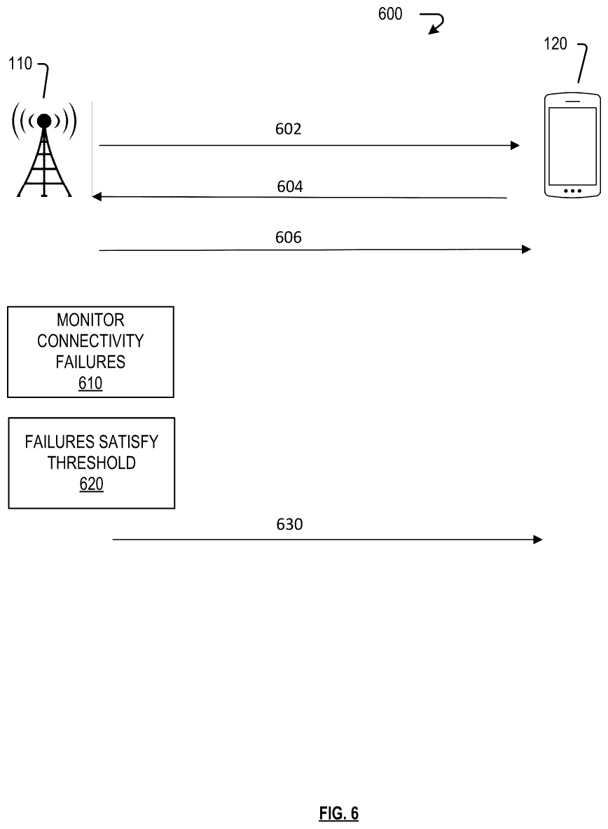

FIG. 6 illustrates a bandwidth parts allocation scenario 600 in accordance with embodiments described herein. The bandwidth parts allocation scenario 600 involves multiple exchanges between the access node 110 and the wireless device 120. At 602, the access node 110 broadcasts its available bandwidth to the wireless device 120. In response, at 604, the wireless device 120 transmits a UE capability report to the access node 110. The access node 110 responds by configuring the wireless device 120 through an RRC setup or configuration in accordance with the advertised bandwidth parts capabilities.

Processing steps occur at the access node 110 at steps 610 and 620. The processing step 610 includes monitoring connectivity failures such as the AFR and the DCR. At step 620, the access node 110 determines that the failures satisfy the predetermined threshold number of failures and thus determines that the wireless device 120 is falsely advertising its bandwidth capabilities. Accordingly, at 630, the access node 110 reconfigures the bandwidth parts allotted to the wireless device 120 in a manner that differs from the advertised bandwidth capabilities of the wireless device 120. The reconfiguration may be performed, for example, through an RRC reconfiguration message from the access node 110 to the wireless device 120.

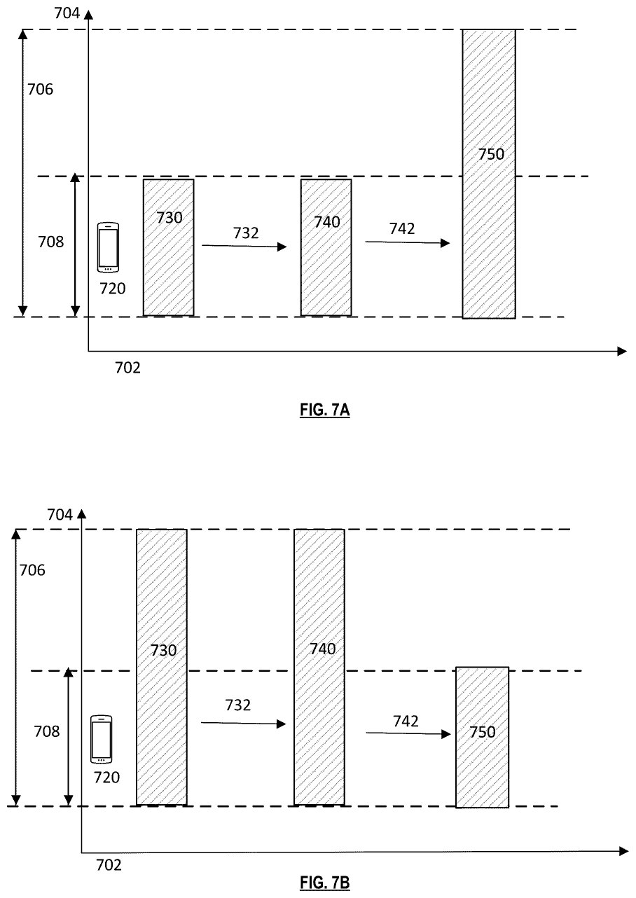

FIGS. 7A and 7B illustrate two different bandwidth parts allocation scenarios. Both FIGS. 7A and 7B illustrate bandwidth in megahertz (MHZ) along the y axis at 704 and time along the x axis at 702. A full bandwidth 706 available from the access node may be, for example, 100 MHZ. A partial bandwidth 730 advertised by the wireless device 720, may be for example 50 MHZ. At 732, UE capability exchanges may advertise the partial bandwidth 730 as the bandwidth capability of the wireless device 720, Thus, the wireless device 720 may be allotted the advertised partial bandwidth through RRC setup at 740. However, upon finding that a threshold number of connectivity failures occur with this setup, the bandwidth parts allocation system 200 described herein performs RRC reconfiguration at 742 to allot the entire bandwidth 750 to the wireless device 720.

FIG. 7B illustrates the opposite scenario, in which the wireless device 720 advertises the full bandwidth 730 through the UE capability message at 732 and is allotted the full bandwidth at 740. After experiencing the threshold number of failures, the wireless device 720 is reconfigured through an RRC reconfiguration message at 742 to a partial bandwidth configuration 750.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
monitoring connectivity failures of a wireless device after the wireless device has been configured by an access node having an available bandwidth, the configuration based on received capability information by assigning an advertised supported bandwidth to the wireless device;
comparing a number of monitored connectivity failures to a predetermined threshold number of connectivity failures;
determining that the number of monitored connectivity failures meets the predetermined threshold number; and
triggering a reconfiguration of the wireless device to utilize a new assigned bandwidth that differs from the advertised supported bandwidth received from the wireless device.

2. The method of claim 1, further comprising receiving, in response to a broadcasted available bandwidth from the access node, capability information from a wireless device including the advertised supported bandwidth.

3. The method of claim 2, further comprising performing radio resource control (RRC) setup based on the received capability information to assign the advertised supported bandwidth to the wireless device.

4. The method of claim 1, wherein the advertised supported bandwidth includes one more bandwidth parts equaling less than the available bandwidth, further comprising reconfiguring the wireless device to utilize all of the available bandwidth.

5. The method of claim 1, wherein the advertised supported bandwidth equals the available bandwidth, further comprising reconfiguring the wireless device to utilize one or more bandwidth parts equaling less than the available bandwidth.

6. The method of claim 1, wherein monitoring connectivity failures comprises monitoring an access failure rate (AFR) of dropped call rate (DCR).

7. The method of claim 1, further comprising providing an operator configurable predetermined threshold.

8. The method of claim 1, further comprising implementing a counter to monitor the connectivity failures.

9. The method of claim 1, further comprising triggering a correction to the capability information transmitted by the wireless device to alter the advertised supported bandwidth.

10. The method of claim 1, further comprising identifying a device type for each wireless device meeting or exceeding the predetermined threshold number.

11. The method of claim 10, wherein further comprising triggering a software upgrade for the identified device type.

12. A system comprising:
a memory storing data and instructions; and
a processor executing the stored instructions to perform operations including:
triggering radio resource control (RRC) configuration based on advertised supported bandwidth capability information from a wireless device to assign the advertised supported bandwidth to the wireless device;
monitoring connectivity failures of the wireless device;
comparing a number of the monitored connectivity failures to a predetermined threshold number of connectivity failures;
determining that the number of monitored connectivity failures meets the predetermined threshold number; and
reconfiguring the wireless device to utilize a new assigned bandwidth that differs from the advertised supported bandwidth received from the wireless device.

13. The system of claim 12, wherein the advertised supported bandwidth includes one more bandwidth parts equaling less than an available bandwidth.

14. The system of claim 13, the operations further comprising reconfiguring the wireless device to utilize all of the available bandwidth.

15. The system of claim 12, wherein the advertised supported bandwidth equals an available bandwidth.

16. The system of claim 15, the operations further comprising reconfiguring the wireless device to utilize one or more bandwidth parts equaling less than the available bandwidth.

17. A method comprising:
triggering radio resource control (RRC) configuration based on advertised supported bandwidth capability information from a wireless device to assign the advertised supported bandwidth to the wireless device;
determining that a number of connectivity failures of the wireless device having the assigned advertised supported bandwidth meets or exceeds a predetermined threshold;
reconfiguring the wireless device to utilize a new assigned bandwidth that differs from the advertised supported bandwidth received from the wireless device; and
triggering a correction to the advertised supported bandwidth transmitted by the wireless device.

18. The method of claim 17, wherein the advertised supported bandwidth includes one more bandwidth parts equaling less than an available bandwidth, further comprising reconfiguring the wireless device to utilize all of the available bandwidth.

19. The method of claim 17, wherein the advertised supported bandwidth equals an available bandwidth, further comprising reconfiguring the wireless device to utilize one or more bandwidth parts equaling less than the available bandwidth.

20. The method of claim 17, further comprising identifying a device type for each wireless device meeting or exceeding the predetermined threshold and triggering a software upgrade for the identified device type.
